(19) United States
(12) Patent Application Publication
(10) Pub. No.: US 2007/0087080 A1
(43) Pub. Date: Apr. 19, 2007

(54) Injection unit, and method for the adjustment thereof

(76) Inventor: Robert Weinmann, Weesen (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/571,286

(22) PCT Filed: Aug. 23, 2004
(86) PCT No.: PCT/CH04/00535

§ 371 Date: Dec. 26, 2006

(30) Foreign Application Priority Data
Sep. 9, 2003 (CH) 1540/03

(51) Int. Cl. B29C 45/46

(52) U.S. Cl. 425/574

(57) ABSTRACT

The invention relates to a method and an injection unit which is movable on runners (6) of the frame (7) of an injection molding machine with the aid of a running gear (40) and comprises a drive unit (10, 23) for axially displacing and pressing the plasticizing cylinder (2) to the injection mold. According to the invention, the tip (16) of the plasticizing cylinder (16) is adjusted on both a vertical and a horizontal plane via a slight rotary movement of the entire injection unit (1) prior to the production if the concentric sealing connection to the injection port (17) of the mold is insufficient. The inventive injection unit (1) is supported via a support (5) that is disposed so as to be movable on the frame (7) of the injection-molded part while being provided with an individual drive unit (10, 23) via which the plasticizing cylinder (2) can be pressed to the injection mold so as to create a concentric sealing connection thereto.

### TECHNICAL DOMAIN

The invention relates to an injection unit which is moveable on runners of the frame of an injection molding machine with the aid of a running gear and comprises a drive unit for axially displacing and pressing the plasticizing cylinder to the injection mold.

### PRIOR ART

Besides the actual molds and the locking mechanism for the molds, the injection unit of an injecting molding machine is one of the main subassemblies of an injection molding machine. The central function of the injection unit lies in the processing of the plastic melt, the metered delivery of the melt into the cavities of the injection mold and the buildup and maintenance of the required pressure for the injection-molded parts until they solidify.

In practice, there are several known possibilities for transferring the melt from the plasticizing cylinder into the mold. If the plasticizing cylinder has a nozzle seal, the individual phases of injection can be defined within clear limits, both chronologically and with respect to pressure. If, however, the so-called freezing of the melt in the transitional zone between the plasticizing worm and entry into the form is utilized, the corresponding parameters must be additionally taken into account in the control/regulation system. In any case, the mechanical reaction forces must be compensated from the interior pressure of the melt into the two halves of the mold throughout the entire phase, that is, from the beginning of the mold filling phase to the end of the subsequent pressure phase. The compensation forces relative to the entire locking unit are absorbed through corresponding components, especially the drive as well as a column brace.

Via the injection unit, the plasticizing cylindrical tip must be pressed firmly enough against the mold so that under no circumstances does the melt pressure open the point of contact between the plasticizing cylinder tip and the mold, thereby allowing melt to emerge. The emergence of melt is detrimental with respect to the cleaning of the applicable machine parts. But a far more serious drawback lies in the obstructive effect with regard to the weight accuracy of the injection molded parts, because an uncontrollable amount [of melt] is lost in the transfer zone, even when the dosing of melt is as accurate as possible. Over a prolonged period of time, opening of the point of contact between the plasticizing cylinder tip and the mold was prevented in that the pressing force of the plasticizing cylinder for the entire casting cycle was kept, to a significant degree of certainty, constant and at the greatest pressing force. However, more recent measurements have shown that when the pressing force is too high, the die to which the pressure is being applied is mechanically deformed, especially during the phase in which a corresponding melt pressure does not yet prevail. In addition to possible damage to the mold, this can also compromise the quality of the injection molded parts.

As a result of the realizations described above, solutions have recently been achieved that
a) optimize the pressing forces of the injection unit by means of control/regulation of the corresponding motor drive forces, and
b) ensure, by means of structural designs, an effective seal between the plasticizing cylinder tip and the mold, even in extreme situations.

With French patent specification No. 1 184 455, a basic solution for pressing on the injection unit was essentially invented, and it constitutes a successful practical solution to this day. In this connection, the pressing force is controlled automatically. The injection unit cylinder is pressed on by means of a hydraulic piston. The relatively large pressing forces are offset by two tension rods. The two tension rods are arranged in a shared plane with the axle of the plasticizing cylinder. This results in direct balancing of the pressure and pressing forces, a significant advantage.

EP-PS 0 422 224 has distanced itself from the approach of direct force balance and proposes making the injection unit moveable on runners of the frame of an injection molding machine. Using an electric motor, the necessary force is converted into linear motion via a ball spindle overdrive so that the plasticizing cylinder can be moved and pressed. However, the buildup of the maximum pressing force does not take place directly via the motor torque, but rather via the tensile force built up in two springs immediately following contacting of the mold. The equilibrium between the elastic forces and the relational forces takes place completely via the frame of the injection molding machine.

The major drawback of solutions based on EP 9 422 224 lies in the eccentric generation of the pressing force. EP 0 422 224 may avoid the problem of mold deformation by means of suitable control of the pressing force. What remains unresolved, however, are the uncontrollable forces that develop, be it from inaccuracies in the structure of an inadequate centering of the plasticizing cylinder tip and the mold injection port or from the eccentricity of the power delivery. In this connection, it must be taken into account that contact loads on the order of 100 kg/cm² to 300 kg/cm² develop as a result of the pressing forces. These contact loads between the plasticizing cylinder tip and the corresponding contact point of the injection mold may transfer considerable lateral forces, due to powerful friction locking. Because of deformation of the machine parts subjected to the greatest amount of pressure, the eccentric generation of force results in controllable effects of force, which also apply to the dies. This leads to abrasion on the nozzle and mold, especially during pressure buildup. Any divergence from completely centric pressing can cause problems with regard to the sealing connection.

EP 0 627 289 comes about from the basic concept of direct force balance in close proximity to the plasticizing cylinder in accordance with FR-PS 1 184 455. In terms of the design, the injection unit encompasses a support unit that is moveable on runners of the frame. The visible drawback lies in the tremendous complexity required for the axial displacement and pressing function of the plasticizing cylinder resulting from the use of two parallel guide columns.

DE 195 80 020 proposes a concept similar to that of EP 0 627 289. As a special solution, it is proposed that following application, the injection nozzle is deformed with the mold and the nozzle pressing force is rendered non-elastic, depending on the injection force or the pressure of the injection material. Although it combines several advantages of various solutions, this solution has only been partly successful in practice. The solution according to DE 195 80 020 also requires considerable structural complexity, due to the double arrangement of the guide column and the force balance.

The underlying goal of the invention is to search for a solution that is structurally uncomplicated and permits central power delivery with the best possible sealing connection, but does not include the described drawbacks of the prior art solutions.

### DESCRIPTION OF THE INVENTION

The inventive solution is characterized by the fact that the injection unit is supported by a support which is moveable on runners of the injection molding machine's frame and comprises a drive unit for pressing the plasticizing cylinder to the injection mold while achieving a concentric sealing connection.

Surprisingly, with the new invention all key advantages of the solutions of the prior art can be integrated into an injection unit and, additionally, an optimal sealing connection can be achieved, without the disadvantages specifically described in each case.

The support simultaneously performs the support and displacement functions. This makes it possible to utilize the advantages of EP 0 422 224 with regard to access to the plasticizing cylinder.

The injection worm is completely exposed, permitting unobstructed access for all necessary work, especially cleaning work, as well as unobstructed visual inspection.

What is decisive, however, is the fact that there is a concentric sealing connection when the plasticizing cylinder is pressed, so that lateral forces and the resulting abrasion can be virtually avoided.

In the new solution, the support is inserted as a separate component. In various embodiments, the support can assume additional functions, as explained below. In an especially preferred embodiment, the support is designed as a running gear, with an undercarriage preferably comprising four guide shoes. This means that the support, together with the running gear, fully supports the injection unit. The support advantageously has two upward-oriented lateral support cheeks, which provide the plasticizing cylinder with articulated support via rotary pins.

The injection cylinder is provided with a slight pivoting capacity in a vertical plane for adjustment of the nozzle tip. The forces produced by an individual drive are introduced concentrically relative to the sealing connection. Although power generation takes place at a distance from and in parallel to the axis of the plasticizing cylinder, power transmission through the articulated connection does not result in any lateral forces being exerted on the mold. According to another advantageous embodiment, the support also features a downward-facing fish joint with a second joint for a drive axis. As a result, power transmission occurs through joints in both the upper section of the support and the lower section of the support, the active axis of the fish joint connection being disposed at the center of the machine and in parallel to the axis of the plasticizing cylinder. The active axis is preferably disposed at the frame level, especially below the level of the runners, thereby freeing up the active zone around the plasticizing cylinder. According to another advantageous embodiment, the individual drive has an electric motor, especially a servo motor, as well as a spindle overdrive.

The advantages of EP 0 422 224 are thus fully utilized with respect to the individual drive, while its drawbacks are not. In the solution according to EP 0 422 224, substantial lateral forces are generated whenever there is any inaccuracy in the interplay among the components, especially whenever there is any deformation in the components. The pressing force must be relatively large during the pressing phase in the injection molding process, especially as the plasticizing worm generates static pressure levels of 1000 to 2000 bar in the melt. The pressing force must always be greater than the opening forces resulting from the pressure of the melt material in the mold, so as to avoid any development of gaps between the tip of the plasticizing worm and the mold. If the tip of the plasticizing worm is pressed concentrically against the mold injection port, an optimal sealing connection develops, thereby avoiding any possible lateral force (lateral to the axis of the plasticizing worm).

According to an especially advantageous embodiment, it is proposed that the support in the region between the upper rotary pins and the lower joint and the running gear be rigidly formed, with deformation under stress being close to zero. As a result, the support, even under the greatest possible load, does not cause any interference in the direction of the pressing force resulting from the effects of forces caused by changes, e.g., bending. The guide shoes are advantageously designed as spherical rotary spindles, the horizontal spacing with respect to the fish joint connection of the tension-stressed guide shoes is greater than the corresponding spacing of the pressure-stressed guide shoes. As a result, the deformation caused by differences in softness and/or the corresponding K factor in the hardness of the spherical rotary spindles can be offset or eliminated with regard to tension and pressure.

As is known in the art, the injection unit includes a drive unit for the rotational and axial movement of the plasticizing worm, said drive unit, according to the new invention, being supported by the support as well as an additional guide shoe unit on the frame, wherein the plasticizing cylinder is firmly connected to the drive unit.

The injection unit also includes an additional guide shoe unit with a lower drive bridge, on which the rear section of the drive unit is adjustably supported, said support preferably being achieved with a rotary pin. This allows the plasticizing cylinder, together with the drive unit, to perform a slight rotational movement, in the manner of a rocker, around the rotary pin as a center of rotation. The objective lies in the best possible adjustment of the plasticizing cylinder tip relative to the mold injection port. To this end, the additional guide shoe unit preferably has one adjustment device for vertical adjustment and another for an additional lateral adjustment. This enables adjustments to be made in both vertical and horizontal directions. The support and running gear are located in the front section and the other guide shoe in the rear section of the injection unit; the running gear having four guide shoes and the guide shoe unit having two guide shoes.

The upper rotary pins are at least approximately disposed in a shared horizontal plane with the axis of the plasticizing cylinder, so that during adjustment of the plasticizing cylinder tip a pivoting movement is possible in both a horizontal and vertical direction.

The new invention also relates to a method for the adjustment of an injection unit which is moveable on runners of the frame of an injection molding machine with the aid of a running gear and comprises a drive unit for axially displacing and pressing the plasticizing cylinder to the injection mold, and is characterized by the fact that, when there is an insufficient centric sealing connection, the mold tip and the plasticizing cylinder tip are adjusted by means of a rotational movement of the entire injection molding unit in both a vertical and horizontal plane prior to production.

### BRIEF DESCRIPTION OF THE INVENTION

The invention will now be explained in further detail on the basis of a few exemplary embodiments.

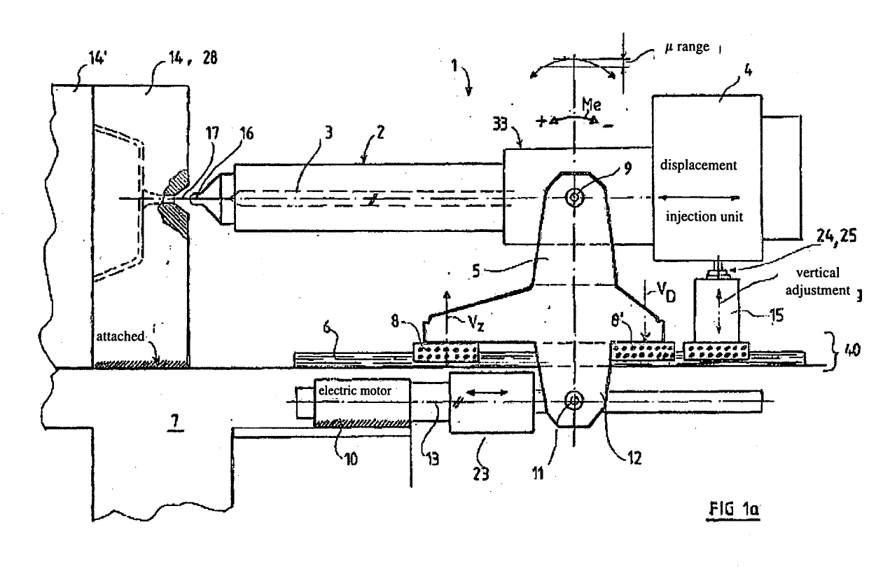

FIG. 1a shows, schematically, the new solution in a lateral view.

FIG. 1b is an example of a plasticizing cylinder tip on a larger scale during the approach to the injection mold port;

FIG. 1c shows FIG. 1b during pressing.

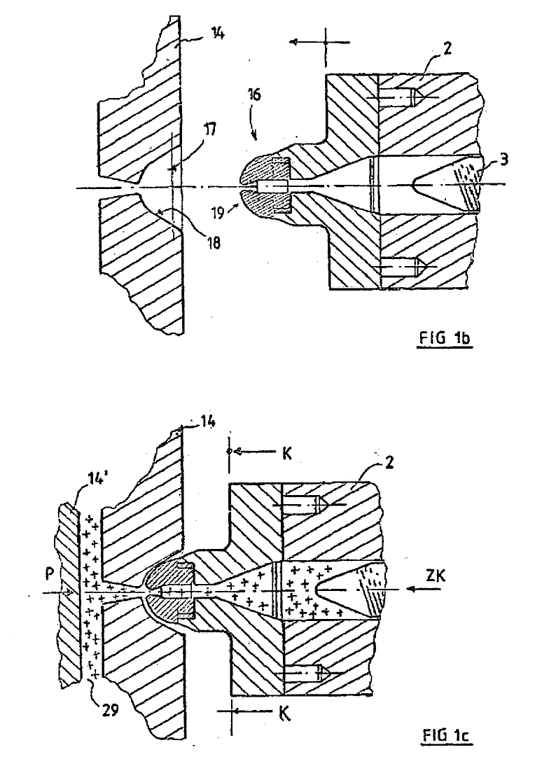

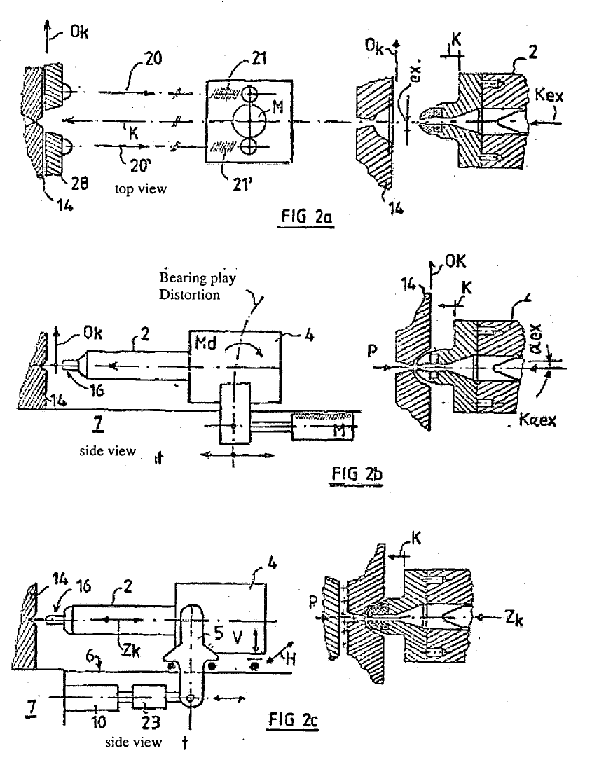

FIGS. 2a to 2c show various dispositions for applying the pressing force of the plasticizing cylinder.

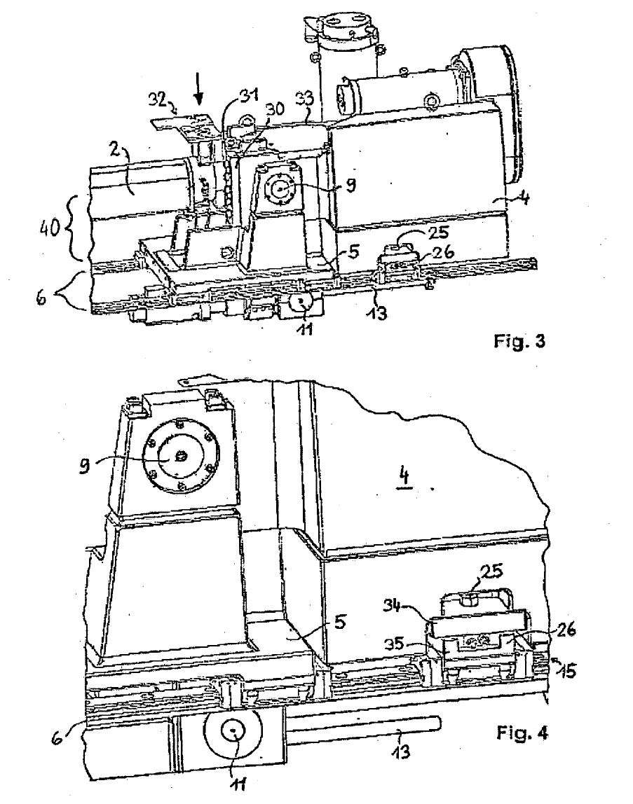

FIG. 3 shows a 3D image of the most important components of FIG. 1.

FIG. 4 shows a section of FIG. 2, in relation to the displacement elements, on a larger scale.

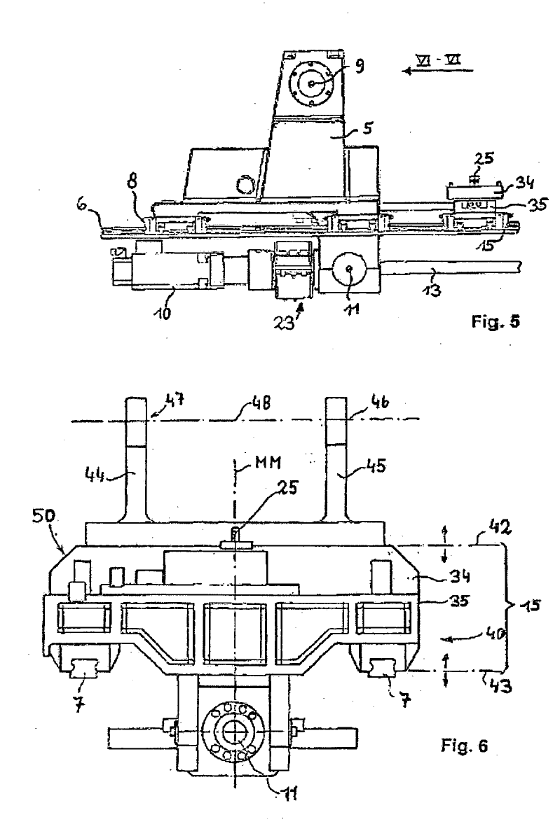

FIG. 5 shows the support with running gear and driving means, as well as the other guide shoe unit.

FIG. 6 shows FIG. 5 from the direction of arrow VI-VI.

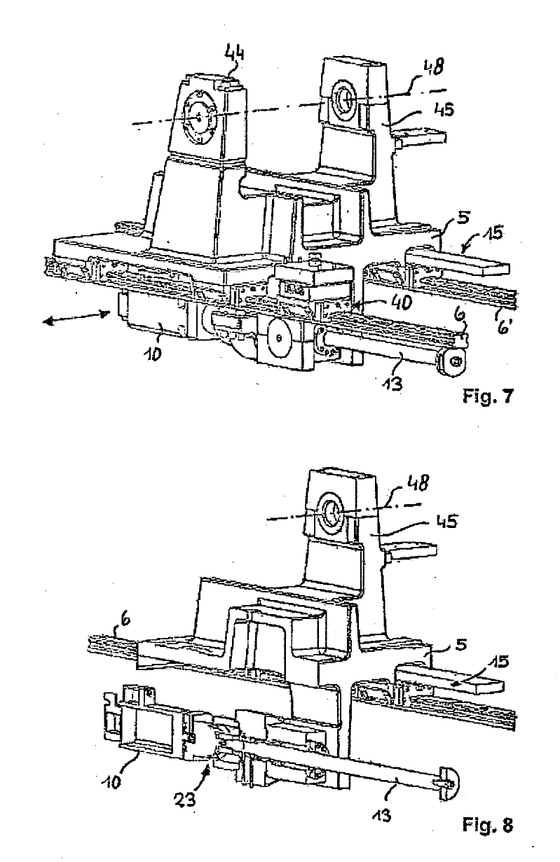

FIG. 7 shows the support with running gear, as well as the other guide shoe unit, in perspective view.

FIG. 8 shows a section, in a 3D depiction, through the support, as well as the other guide shoe unit.

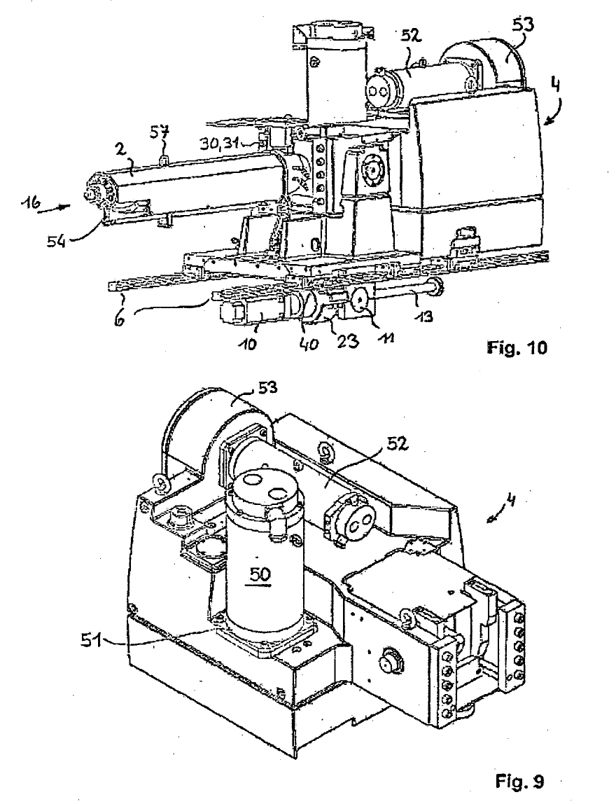

FIG. 9 shows a drive unit for generating the rotational and axial movement of the plasticizing worm.

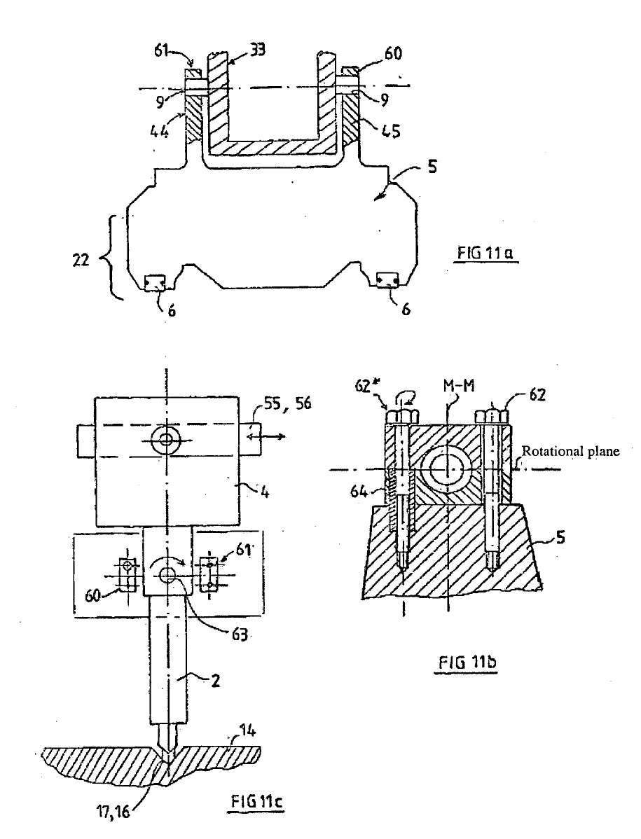

FIG. 10 shows a complete injection unit with a view of the injection unit cylinder tip.

FIGS. 11a to 11c show the possibility of adjustment of the plasticizing cylinder tip to conform to the injection mold port.

### METHODS AND EXECUTION OF THE INVENTION

In the following, reference is made to FIG. 1, which schematically depicts the most important structural elements of a new solution. The entire injection unit 1 has a plasticizing cylinder 2 with a plasticizing worm 3. For cleaning purposes and servicing, the plasticizing cylinder 2 is detachably connected to a drive unit 4 and the plasticizing worm 3 is mechanically connected to the corresponding drive motors. The plasticizing cylinder 2 is supported with the drive unit 4 via the support 5 on runners 6 on the frame 7 of the injection molding machine. Only the fixed die 14 is shown in FIG. 1a, while FIGS. 1b and 1c show an enlarged section of a plasticizing cylinder tip 16 with the corresponding injection mold port 17. For purposes of displacement, the support 5 is moveable on guide shoes 8, 8′ on the runners 6. The plasticizing cylinder 2 and the drive unit 4 pivot slightly in the support 5 via rotary pins 9. The force required for displacing and pressing the plasticizing cylinder 2 is provided by an electric motor 10, which engages the lower section 12 of the support 5 through a joint 11. The force generated by the electric motor 10 is applied via an axis 13 and a spindle overdrive 23. In this connection, it is important that the axis 13, at least in the initial position, is disposed in parallel to the axis of the plasticizing worm 3, as indicated by the parallel symbol ∥. Adjustments can be made in both a horizontal and a vertical plane. Vertical adjustment is achieved by means of a height adjustment with the wedge 24. Horizontal adjustment is achieved by means of horizontal displacement of the horizontal adjustment mechanism 26. In both cases, the drive unit is forcibly guided across a central support 25.

Adjustment results in a minimal movement in the support away from the vertical line, which is indicated by an arrow and +/−. In the new solution, the change with respect to height results from the sum of all distortions in the micro range.

An important basis for an optimal sealing connection also lies in the articulated transmission of the pressing force through the joints 9 and 11. The pressing forces are completely offset by a fixed connection between the die 14 and/or a die clamping plate 28 and the frame 7, on the one hand, and between the electric motor and the frame 7, on the other, the moment Me generated by the eccentric engagement of the electric motor 10 being compensated by a vertical tensile force VZ and a vertical compression force VD. As a result of a correspondingly rigid design of the frame 7, any deformation occurring here can be reduced to such an extent that it does not adversely affect the sealing connection when subjected to a load. The rear section of the drive unit 4 is supported by an additional guide shoe unit 15. FIG. 1b shows the plasticizing cylinder tip 16 on a larger scale as it approaches the injection port 17 of the fixed die 14. The injection port 17 has a sealing lip 18, which must be of sufficient size and capable of being easily cleaned. A corresponding sealing lip 19 is applied to the plasticizing cylinder tip 16 itself. If at all possible, the sealing connection must be guaranteed without lateral forces QK throughout the entire injection process, but especially during the pressure phase. The primary forces are, on the one hand, the pressure P in the melt 29, which is indicated by +− signs (FIG. 2c), and the mechanical pressing force K (ZK), which remains concentric relative to the sealing surface during the pressure phase. As a result, all lateral forces QK are avoided.

FIGS. 2a and 2b depict, in highly schematic form, the two typical solutions of the prior art, wherein FIG. 2a corresponds approximately to the solutions according to FR-PS 1 184 455, DE 195 80 20 and EP-PS 0 627 289, and FIG. 2b to the solution according to EP 0 422 224.

FIG. 2a shows, in idealized form, the force balance through two tension rods 20, 20′ arranged in parallel with the injection cylinder. The motor drive force is provided by two drives 21, 21′, which are disposed in the injection unit 22. An eccentric force Kex results from the variance ex if the axis of the injection port 17 of the die 14 does not exactly match the axis of the injection cylinder. Lateral forces QK cannot be avoided if, for example, the mold is assembled imprecisely.

FIG. 2b shows a solution in which the plasticizing cylinder tip 16 is eccentrically pressed to the die 14. As a result of the existing bearing clearances as well as the sum of all distortions, the eccentricity of the application of force (K & ex) of the motor drive results in an eccentric angular deviation & ex. and, therefore, even greater lateral forces Qk, which impair the sealing connection and produce uncontrollable forces, especially during pressure buildup, and cause frictional forces as well as abrasion of the sealing surfaces 18, 19.

FIG. 2c utilizes all advantages of eccentric force generation and, furthermore, can prevent any lateral forces Qk. An especially interesting condition lies in the possibility of adjustment of the plasticizing cylinder tip 16 in both a horizontal and vertical direction via the articulated support (FIG. 11).

FIG. 3 is a 3D depiction of the most important components of a concrete embodiment of the new solution. A section of the plasticizing cylinder 2, which is firmly connected to the drive unit 4 by means of an anchor 30, is visible in the upper part of the figure. For the purpose of servicing and cleaning activities, the plasticizing cylinder 2 can be detached by means of screws 31. The raw material is fed into the plasticizing worm through a feed port 32. In their normal operating state, the plasticizing cylinder 2 and the drive unit 4 constitute a rigid unit, the drive unit 4 being supported by a transitional element 33 in the rotary pin 9 and mounted in the support 5. The support, for its part, features guide shoes 8, 8′, which are moveably disposed on the runners 6. The rear section of the drive unit 4 rests on the additional guide shoe unit 15, so that a significant portion of the weight of the drive unit is absorbed in the rear section. Vertical adjustment of the plasticizing cylinder tip 16 is achieved by means of a height adjustment 24 through the corresponding displacement of a wedge. Horizontal adjustment is achieved by means of a horizontal adjustment 26 through movement of a sliding plate 34 relative to a sliding element 35.

FIG. 4 is an enlarged section and shows, as an alternative to FIG. 3, a compact version of the guide shoes. As shown in FIG. 4, in the operating state, there is an approximate equilibrium between the mass of the plasticizing cylinder 2 and that of the gear unit 4. However, if the plasticizing cylinder 2 is disassembled, the solution shown in FIG. 3 provides a better distribution of mass in relation to the support.

FIGS. 5 and 6 show the support 5 with running gear 40. The running gear 40 consists mainly of four guide shoe 8, 8′, each of which comprises a linear guidance system with recirculating linear ball bearings. FIG. 6 is a view from behind, according to arrow VI-VI. The additional guide shoe unit 15 is visible between the dot-dash lines 42, 43, and the parts visible from the rear are visible below and above, drive parts for the support 5 below and two lateral support cheeks 44 and 45, each having bore holes 46 and 57 for the rotary pins 9, above. The axis of rotation 9 is indicated by the dot-dash line 48. The other guide shoe unit features an adjustment device at its center, said device having a central support 25 at the center of the machine M-M.

FIGS. 7 and 8 are perspective views of the running gear 40 and of the additional guide shoe unit. The solid and/or rigid design of the support 5 is clearly recognizable. In contrast, the additional guide shoe unit 15 is built more lightly, because it merely performs a supporting and adjusting function for adjustments. The forces for pressing are conducted entirely through the support 5.

The key components are recognizable once again in FIG. 8. FIG. 8 is a section of the machine center plane (M-M).

FIG. 9 shows the drive unit 4, which, aside from the joint, is not part of the subject matter of the new invention. The drive unit 4 features a drive motor 50 with a gear 51 for rotational movement of the plasticizing worm 3 as well as a drive motor 52 with gears 53 for the axial movement of the plasticizing worm 3.

FIG. 10 shows a frontal view of a complete injection unit. The noticeably large mass of the plasticizing cylinder 2 and of the drive unit 4 are recognizable. Attached to the front of the plasticizing cylinder are a nozzle lock 54 and a hook 57, which is intended for the assembly/disassembly of the plasticizing cylinder. It is assumed that the inner operating elements for both the plasticizing cylinder 2 and the drive unit are known.

FIGS. 11a, 11b and 11c show the two adjustment options for adjusting the plasticizing cylinder tip 16 relative to the injection mold port 17. In FIG. 6, the additional guide shoe unit has an upper sliding element 55, which is moveably supported on a moving element 56. The sliding element 55 can be horizontally displaced after loosening the corresponding clamping screws and vertical adjustment can be achieved by means of a corresponding wedge adjustment. An important issue in this context is that both adjustment directions must only be designed for adjustments within a range of millimeters in order to achieve a perfect sealing connection, in such a manner that the two sealing surfaces 18, 19 fit neatly together. Vertical adjustment is achieved by means of a height adjustment using a correspondingly adjustable wedge. The adjustment in a horizontal plane is schematically depicted in FIGS. 11a to 11c. The rotary pins 9 are supported at both ends in pillow bearings 60 and 61. During production operation, the pillow bearings 60, 61 are rigidly connected to the support 5 via clamping screws 62. All clamping screws 62 are loosened for adjustment purposes. By means of a slight horizontal displacement of the sliding element 55 relative to the moving element 56, the drive unit 4, together with the plasticizing cylinder 2, is rotated slightly around a virtual axis 63. For this purpose, the injection unit is pushed until it contacts the sealing surfaces 18 and 19, so that a perfect sealing connection is formed during adjustment. The adjustment is performed simultaneously in both the horizontal and vertical planes. It is very important, in this connection, that inaccuracies in the mold assembly, in particular, can be rendered harmless. The dies must be installed with great precision relative to one another and the mold components, so as to allow for subsequent adjustment of the plasticizing cylinder tip 16 relative to the injection port 17. To ensure that the rotational movement of the drive unit 4 and the plasticizing cylinder 2 can take place in a defined manner, a guide sleeve 64 with running clearance is preferably mounted onto one clamping screw 62*. This results in greater security in the event that the remaining clamping screws should ever be tightened insufficiently.

1. An injection unit which, with a drive unit as well as a drive block disposed in the rear section, is moveable on runners (6) of the machine frame (7) of an injection molding machine and comprises a drive unit (10, 23) for axially displacing and pressing the plasticizing cylinder (2) to the injection mold,
characterized in that
the injection unit (1) is supported in an articulated manner by a support (5) which is moveable on runners of the frame (7) of the injection molding machine and comprises an individual drive (10, 23) for pressing the plasticizing cylinder (2), with slight pivotability of the nozzle tip, to the injection mold (14) while achieving a centric sealing connection, and the rear section of the drive block is adjustably supported.

2. The injection unit according to claim 1,
characterized in that
the support (5) is formed as a running gear (40) with an undercarriage (22) preferably comprising four guide shoes (8, 8′).

3. The injection unit according to claim 1 or 2,
characterized in that
the support (5) has two lateral support cheeks (44, 45), which provide the plasticizing cylinder (2) with articulated support via rotary pins (9).

4. The injection unit according to one of claims 1 to 3,
characterized in that
the support (5) features a downward-facing fish joint (12) with a joint (11) for a drive axis (13).

5. The injection unit according to one of claims. 1 to 4,
characterized in that
the active axis of the fish joint connection (12) is disposed at the center of the machine (M-M) and in parallel to the axis of the plasticizing cylinder (2).

6. The injection unit according to claim 5,
characterized in that
the active axis is preferably disposed at approximately the frame level, especially below the level of the runners (6).

7. The injection unit according to one of claims 1 to 6,
characterized in that
the individual drive has an electric motor (10), especially a servo motor, as well as a spindle overdrive (23).

8. The injection unit according to one of claims 1 to 7,
characterized in that
the support (5) in the region between the upper rotary pins (9) and the lower joint (11) and the running gear (40) is rigidly formed, with deformation under stress being close to zero.

9. The injection unit according to one of claims 1 to 8,
characterized in that
the guide shoes (8, 8′) are designed as spherical rotary spindles, the horizontal spacing with respect to the tension-stressed guide shoes-(8, 8′) being greater than the corresponding spacing of the pressure-stressed guide shoes (8, 8′), to offset the K factor with regard to tension and pressure balancing.

10. The injection unit according to one of claims 1 to 9,
characterized in that
the injection unit (1) includes a drive unit (4) for the rotational and axial movement of the plasticizing worm (3), said drive unit being supported by the support (5) as well as an additional guide shoe unit (15) on the frame, wherein the plasticizing cylinder (2) is firmly connected to the drive unit (4).

11. The injection unit according to one of claims 1 to 10,
characterized in that
the additional guide shoe unit (15) has a lower drive bridge, on which the drive unit (4) is supported, said support being provided by a central support (25).

12. The injection unit according to claim 11,
characterized in that
the additional guide shoe unit (15) has an adjustment device for both vertical and horizontal adjustment.

13. The injection unit according to one of claims 1 to 12,
characterized in that
the support (5) and running gear (40) are disposed in the front section and the other guide shoe unit (15) in the rear section of the injection unit (1), the running gear (40) having four guide shoes and the guide shoe unit (8, 8′) having two guide shoes.

14. The injection unit according to one of claims 1 to 13,
characterized in that
the rotary pins (9) are at least approximately disposed in a shared horizontal plane with the axis of the plasticizing cylinder (2), in such a manner that during adjustment of the plasticizing cylinder tip (16) a pivoting movement can be completed in both a horizontal and a vertical plane.

15. Method for the adjustment of an injection unit (1), a drive block disposed in the rear section, which is moveable on runners (6) of the machine frame of an injection molding machine with the aid of a running gear (40) and comprises a drive unit for axially displacing and pressing the plasticizing cylinder (2) to the injection mold (14),
characterized in that
when there is an insufficient concentric sealing connection, the plasticizing cylinder tip (16) is adjusted to the injection mold port (17) by means of adjustment of the drive block and corresponding slight rotational movement of the entire injection molding unit (1) in both a vertical and horizontal plane prior to production.
